(19) United States
(12) Patent Application Publication
(10) Pub. No.: US 2024/0338270 A1
(43) Pub. Date: Oct. 10, 2024

(54) METHOD AND APPARATUS FOR RELIABILITY EVALUATION BASED ON MULTIPLE PERFORMANCE DEGRADATION, AND DEVICE

(71) Applicant: China Electronic Product Realiability and Environmental Testing Research Institute, Guangzhou (CN)

(72) Inventors: Guangze Pan, Guangzhou (CN); Dan Li, Guangzhou (CN); Bochen Chen, Guangzhou (CN); Lijun Sun, Guangzhou (CN); Yuanhang Wang, Guangzhou (CN); Wenwei Liu, Guangzhou (CN); Jianfeng Yang, Guangzhou (CN); Xiaojian Ding, Guangzhou (CN)

(21) Appl. No.: 18/591,737

(22) Filed: Feb. 29, 2024

(30) Foreign Application Priority Data
Apr. 4, 2023 (CN) 202310349715.7

(51) Int. Cl. G06F 11/00

(52) U.S. Cl. CPC G06F 11/008

(57) ABSTRACT

The present disclosure relates to a method and an apparatus for reliability evaluation based on multiple performance degradation, a computer device, a storage medium, and a computer program product. The method includes: for each of the multiple performances of a target product, obtaining a plurality of candidate functions that the performance possibly follows, determining a target function that satisfies a preset selection condition from the plurality of candidate functions, and determining a reliability function corresponding to the performance based on the target function; determining coupling relation information between the multiple performances of the target product, and obtaining redundancy information of the multiple performances of the target product; and performing a reliability evaluation on the target product based on the coupling relation information, the redundancy information, and the reliability function of each performance.

### CROSS-REFERENCE TO RELATED APPLICATIONS

The present application claims priority to Chinese patent application No. 202310349715.7, filed on Apr. 4, 2023, the entire content of which is incorporated herein by reference.

### TECHNICAL FIELD

The present disclosure relates to the field of reliability evaluation technologies, and in particular, to a method and an apparatus for reliability evaluation based on multiple performance degradation, a computer device, a storage medium, and a computer program product.

### BACKGROUND

A reliability evaluation refers to using the test or usage information generated at each stage of the product life cycle to obtain an estimate of the product's reliability under a specific condition based on probabilistic statistics. The reliability evaluation of products is an important part of reliability engineering.

### SUMMARY

In a first aspect, the present disclosure provides a method for reliability evaluation based on multiple performance degradation. The method includes:
for each of multiple performances of a target product, obtaining a plurality of candidate functions that the performance possibly follows;
for each of the candidate functions, obtaining a plurality of candidate parameter values for an unknown parameter of the candidate function;
for each of the candidate parameter values, obtaining a correlation parameter between the candidate function, when the unknown parameter of which is the candidate parameter value, and a product performance degradation parameter;
determining a target parameter value from the plurality of candidate parameter values based on the correlation parameter corresponding to each of the candidate parameter values, and using the target parameter value as the parameter value of the unknown parameter of the candidate function to obtain an intermediate function corresponding to the candidate function;
determining a target function that satisfies a preset condition from a plurality of intermediate functions;
determining, based on the target function, a reliability function corresponding to the performance;
determining the coupling relation information between the multiple performances of the target product, and obtaining the redundancy information of the multiple performances of the target product, the coupling relation information being configured to indicate the performances of the multiple performances that are in coupling relation with each other and the performances that are independent of each other, the redundancy information being configured to indicate that the multiple performances of the target product are in a non-redundancy situation or a redundancy situation, the non-redundancy situation being a situation in which the target product fails if any performance of the target product fails, and the redundancy situation being a situation in which the target product fails if all of the performances of the target product fail;
determining a reliability function corresponding to the target product based on the coupling relation information, the redundancy situation information, and the reliability function corresponding to each of the performances;
determining a function of product mean time between failures and a product failure probability function corresponding to the target product based on the reliability function corresponding to the target product;
performing a reliability evaluation on the target product based on the function of product mean time between failures and the product failure probability function.

In an embodiment, the determining the target function that satisfies the preset condition from the plurality of intermediate functions, includes:
determining a correlation parameter between each intermediate function and the product performance degradation parameter, and determining the intermediate function corresponding to the largest correlation parameter as the target function.

In an embodiment, the determining, based on the target function, a reliability function corresponding to the performance, includes:
determining, based on the target function, a Wiener process function, and solving the Wiener process function to obtain a parameter value of an unknown parameter included in the Wiener process function; and
determining, based on the parameter value of the unknown parameter included in the Wiener process function and the target function, a reliability function corresponding to the performance.

In an embodiment, the intermediate function is the candidate function that comprises the parameter value of the unknown parameter.

In an embodiment, the reliability function is the reliability function of the performance degradation and failure.

In a second aspect, the present disclosure also provides an apparatus for reliability evaluation based on multiple performance degradation. The apparatus includes:
a first execution module configured to: for each of the multiple performances included in a target product, obtain a plurality of candidate functions that the performance possibly follows; for each of the candidate functions, obtain a plurality of candidate parameter values for an unknown parameter of the candidate function; for each of the candidate parameter values, obtain a correlation parameter between the candidate function, when the unknown parameter of which is the candidate parameter value, and a product performance degradation parameter; determine a target parameter value from the plurality of candidate parameter values based on the correlation parameter corresponding to each of the candidate parameter values, and use the target parameter value as the parameter value of the unknown parameter of the candidate function to obtain an intermediate function corresponding to the candidate function; determine a target function that satisfies a preset condition from a plurality of intermediate functions; and determine, based on the target function, a reliability function corresponding to the performance;
a second execution module, configured to determine the coupling relation information between the multiple performances of the target product, and obtain the redundancy information of the multiple performances of the target product, the coupling relation information being configured to indicate the performances of the multiple performances that are in coupling relation with each other and the performances that are independent of each other, the redundancy information being configured to indicate that the multiple performances of the target product are in a non-redundancy situation or a redundancy situation, the non-redundancy situation being a situation in which the target product fails if any performance of the target product fails, and the redundancy situation being a situation in which the target product fails if all of the performances of the target product fail; and
a third execution module, configured to determine a reliability function corresponding to the target product based on the coupling relation information, the redundancy situation information, and the reliability function corresponding to each of the performances; determine a function of product mean time between failures and a product failure probability function corresponding to the target product based on the reliability function corresponding to the target product; and perform, based on the function of product mean time between failures and the product failure probability function, a reliability evaluation of the target product.

In an embodiment, the first execution module is specifically configured to: determine a correlation parameter between each intermediate function and the product performance degradation parameter, and determine the intermediate function corresponding to a largest correlation parameter as the target function.

In an embodiment, the first execution module is specifically configured to: determine a Wiener process function based on the target function and solve the Wiener process function to obtain a parameter value of an unknown parameter included in the Wiener process function; and determine the reliability function corresponding to the performance based on the target function and the parameter value of the unknown parameter included in the Wiener process function.

In a third aspect, the present disclosure also provides a computer device, including a memory and a processor, the memory storing a computer program, any step in the first aspect being implemented when the computer program is executed by the processor.

In a fourth aspect, the present disclosure also provides a computer-readable storage medium having a computer program stored thereon, any step in the first aspect being implemented when the computer program is executed by a processor.

In a fifth aspect, the present disclosure also provides a computer program product including a computer program, any step in the first aspect being implemented when the computer program is executed by a processor.

### BRIEF DESCRIPTION OF THE DRAWINGS

FIG. 1 is a schematic flow diagram of a method for reliability evaluation based on multiple performance degradation according to an embodiment;

FIG. 2 is a schematic flow diagram for determining a target function that satisfies a preset selection condition from a plurality of candidate functions according to an embodiment;

FIG. 3 is a schematic flow diagram for obtaining a plurality of intermediate functions according to an embodiment;

FIG. 4 is a schematic flow diagram for determining a reliability function corresponding to performance based on a target function according to an embodiment;

FIG. 5 is a schematic flow diagram for performing reliability evaluation on a target product based on coupling relation information, reliability information, and the reliability function of each performance according to an embodiment;

FIG. 6 is a schematic flow diagram of a method for reliability evaluation based on multiple performance degradation according to another embodiment;

FIG. 7 is a block diagram of a structure of an apparatus for reliability evaluation based on multiple performance degradation according to an embodiment; and

FIG. 8 is a schematic diagram of an internal configuration of a computer device according to an embodiment.

### DETAILED DESCRIPTION OF THE EMBODIMENTS

In order to make the purpose, technical solutions, and advantages of the present disclosure more obvious and understandable, specific implementations of the present disclosure are described in detail below with reference to the accompanying drawings. It should be understood that the specific implementations described herein are only for the purpose of explaining the present disclosure and are not intended to limit the present disclosure.

As used herein, the singular forms “a” “an” and “this/the” may also include plural forms, unless otherwise clearly indicated. It should also be understood that the terms “includes/contains” or “have” etc. indicate the existence of the stated features, wholes, steps, operations, components, parts, or combinations thereof. However, these terms do not exclude the possibility of the existence of one or more other features, wholes, steps, operations, components, parts, or combinations thereof.

A reliability evaluation refers to using the test or usage information generated at each stage of the product life cycle to obtain an estimate of the product's reliability under a specific condition based on probabilistic statistics. The reliability evaluation of products is an important part of reliability engineering.

In conventional technology, only the stochastic degradation process of a single performance of a product is considered in the majority of reliability evaluation methods, that is, the reliability evaluation is performed based on the degradation of a single performance of the product. There is no reliability evaluation method based on multiple performance degradation of products.

Therefore, there is an urgent need for a reliability evaluation method based on multiple performance degradation of products.

In view of this, the present disclosure provides a method for reliability evaluation based on multiple performance degradation.

The method for reliability evaluation based on multiple performance degradation provided in embodiments of the present disclosure can be performed by a computer device. The computer device may be a server or the like.

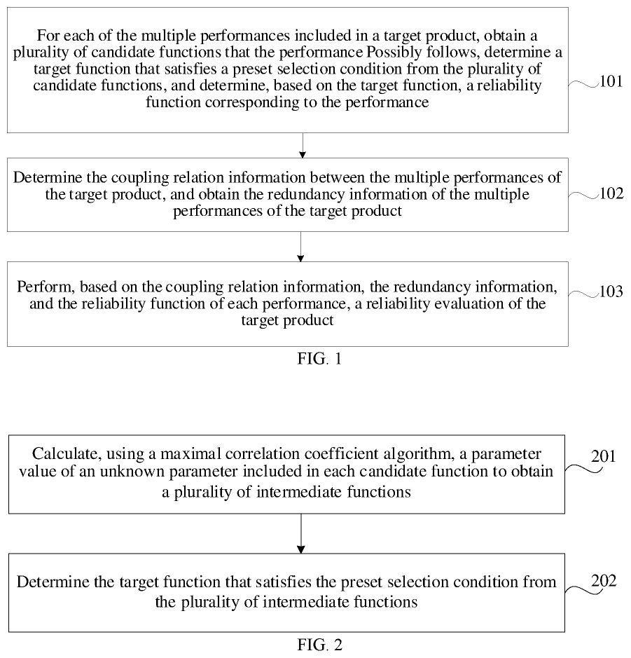

In an embodiment, as shown in FIG. 1, a method for reliability evaluation based on multiple performance degradation is provided. The method includes the following steps S101 to S103.

In step S101, for each of the multiple performances of a target product, a plurality of candidate functions that the performance possibly follows are obtained, a target function that satisfies a preset selection condition is determined from the plurality of candidate functions, and a reliability function corresponding to the performance is determined based on the target function.

In some embodiments, the target product is a product to be subjected to reliability evaluation.

The candidate function refers to a function that is followed by the degradation of the performance parameters of the target product over time, i.e., the performance degradation function of the target product. The degradation of the performance parameters of the target product over time may follow a linear function. Alternatively, the degradation of the performance parameters of the target product over time may follow a specific function. Therefore, the candidate function may be a linear function, a nonlinear function, or a specific function.

In a possible implementation, the plurality of candidate functions that the performance possibly follows may be obtained based on historical reliability evaluation data.

The preset selection condition may be set by the technician in advance. The preset selection condition may be set based on the target product, the performance of the target product, or the target product usage.

The target function is a candidate function that meets the preset selection condition among the plurality of candidate functions. The target function is selected from the plurality of candidate functions, and the target function is the most suitable function for representing the degradation process of performance parameters over time.

In a possible implementation, the target function that satisfies the preset selection condition can be determined from the plurality of candidate functions using a maximal correlation coefficient algorithm.

In another possible implementation, the target product can also be modeled to obtain a performance degradation process model of the target product. The target function that satisfies the preset selection condition is determined from the plurality of candidate functions based on the performance degradation process model.

The reliability refers to the probability that a product completes a specified function under specified conditions and within a specified time. The reliability function refers to a function that can represent reliability.

In a possible implementation, a Wiener process function can be used to determine the reliability function corresponding to the performance, based on the target function.

In another possible implementation, the first order second moment method can also be used to determine the reliability function corresponding to the performance, based on the target function.

In another possible implementation, the center point algorithm can also be used to determine the reliability function corresponding to the performance, based on the target function.

As described above, the target product has a plurality of performances, so it is necessary to perform the above process once for each of the plurality of performances of the target product to obtain a plurality of reliability functions corresponding to the plurality of performances of the target product.

In step S102, the coupling relation information between the multiple performances of the target product is determined, and the redundancy information of the multiple performances of the target product is obtained.

In an optional embodiment of the present disclosure, the coupling relation information is configured to indicate, among the multiple performances, the performances that are coupled to each other and the performances that are independent of each other. The redundancy information is configured to indicate whether multiple performances of the target product are in a non-redundancy situation or a redundancy situation.

The non-redundancy situation refers to a situation in which the target product fails if any performance of the target product fails. The redundancy situation refers to a situation in which the target product fails if all of the performances of the target product fail.

In a possible implementation, the coupling relation information between multiple performances of a target product and the redundancy information of the multiple performances of the target product can be determined based on a performance guideline document of the target product, i.e., a performance specification document of the target product.

In step S103, a reliability evaluation is performed on the target product based on the coupling relation information, the redundancy information, and the reliability function of each performance.

In some embodiments, the reliability evaluation is to evaluate the ability of a product or a system to continuously perform its function over a given time interval under specified conditions.

In a possible implementation, the reliability evaluation of the target product can be performed based on the coupling relation information, the redundancy information, and the reliability function of each performance, using a point estimation algorithm.

In another possible implementation, the reliability evaluation of the target product can be performed based on the coupling relation information, the redundancy information, and the reliability function of each performance, using an interval estimation algorithm.

In some embodiments, after performing the reliability evaluation on the target product, the method further includes: generating an evaluation report based on the reliability evaluation result of the target product, and transmitting the evaluation report to a terminal device, such as a personal computer, a mobile phone, etc., through a network. In this way, engineers can accurately and timely learn the status of the target product, such as the remaining service lift, based on the received evaluation report, facilitating timely maintenance, replacement, and other operations on the target product.

In the above-described method, for each of the multiple performances of a target product, a plurality of candidate functions that the performance possibly follows are obtained. A target function that satisfies a preset selection condition is selected from the plurality of candidate functions. Based on the target function, a reliability function corresponding to the performance is determined. The coupling relation information between the multiple performances of the target product is determined, and the redundancy information of the multiple performances of the target product is obtained. Based on the coupling relation information, the redundancy information, and the reliability function of each performance, a reliability evaluation of the target product is performed. In the method for reliability evaluation based on multiple performance degradation provided in the present disclosure, the reliability functions corresponding to multiple performances are determined based on the target functions corresponding to the multiple performances of the target product, and the target function is preferably selected from multiple candidate functions, so that the accuracy can be improved effectively. After that, the reliability evaluation of the target product is performed based on the coupling relation information between the multiple performances, the redundancy information, and the reliability parameters of the multiple performances. The method can be applied to the reliability evaluation of a variety of target products due to the consideration of the relationship between individual performances. The method provided in the present disclosure can realize the reliability evaluation of multiple performance degradation of a product, and the method not only has a wide scope of application, but also obtains evaluation results with high accuracy.

In one of the embodiments, as shown in FIG. 2, the determining the target function that satisfies the preset selection condition from the plurality of candidate functions includes the following steps S201 to S202.

In step S201, a parameter value of an unknown parameter included in each candidate function is calculated, using a maximal correlation coefficient algorithm, to obtain a plurality of intermediate functions.

In some embodiments, the intermediate function refers to the candidate function that includes the parameter value of the unknown parameter.

In a possible implementation, the parameter values of the unknown parameters of multiple candidate functions can be obtained based on the maximal correlation coefficient algorithm and the multiple candidate functions. The parameter values can then be substituted into the corresponding candidate functions to obtain the plurality of intermediate functions.

In step S202, the target function that satisfies the preset selection condition is determined from the plurality of intermediate functions.

In a possible implementation, as described above, a plurality of intermediate functions have been obtained based on the maximal correlation coefficient algorithm. The intermediate function that satisfies the preset selection condition among the plurality of intermediate functions is determined as the target function.

In another possible implementation, as described above, a plurality of intermediate functions have been obtained based on the maximal correlation coefficient algorithm. Therefore, the target product may also be modeled to obtain a performance degradation process model for the target product. Based on the performance degradation process model, the target function that satisfies the preset selection condition is determined from the plurality of intermediate functions.

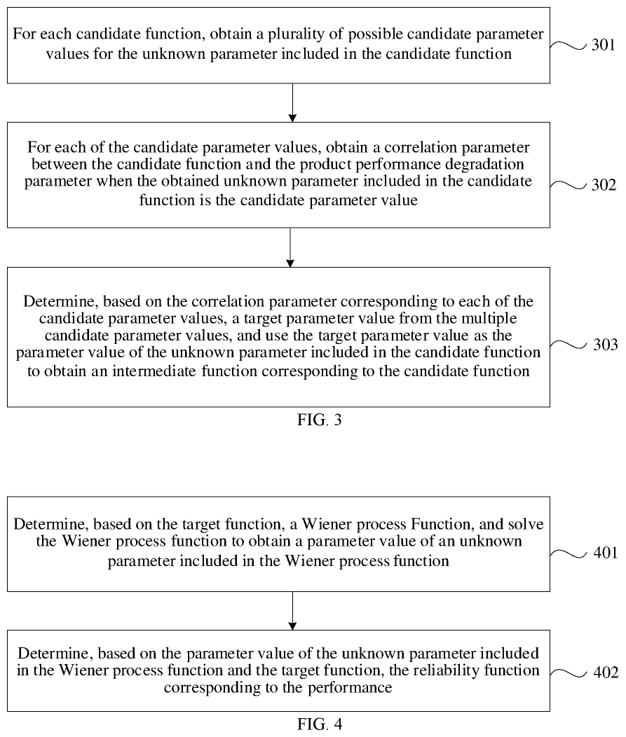

In one of the embodiments, as shown in FIG. 3, the calculating, using the maximal correlation coefficient algorithm, the parameter value of the unknown parameter included in each candidate function to obtain the plurality of intermediate functions includes the following steps S301 to S303.

In step S301, for each candidate function, a plurality of possible candidate parameter values for the unknown parameter included in the candidate function is obtained.

In some embodiments, it is assumed that the target product's candidate function, i.e., the performance degradation function of the target product, is as follows: y=f(β(x)), where y refers to the value of the performance parameter of the target product, f( ) refers to the performance degradation function, i.e., the candidate function, x refers to the working hours of the target product, β(x) refers to a linear function. The present disclosure takes into account that the degradation of the performance parameters of the target product over time is non-linear and therefore assumes that β(x)=β(x;b,k). β(x;b,k) refers to a linear function containing variables x and unknown parameters b and k. Since f(x;b,k) can be equal to exp(kx)−1, β(x;b,k) can also be equal to b×x^{k}, and β(x;b,k) can also be equal to 1−exp(b×x^{k}), there are more than one candidate function y=f(β(x;b,k)).

In a possible implementation, it is assumed that the correlation parameter between the performance degradation value y of the target product and the linear function β(x;b,k) is r, and the total number of target products is n, then the sum of the correlation parameters of the n products is Σᵢ₌₂ⁿrᵢ. The unknown parameters b and k are traversed one by one to obtain multiple sets of possible candidate parameter values for the unknown parameters included in the candidate function.

In step S302, for each of the candidate parameter values, the correlation parameter between the candidate function, the unknown parameter of which is the candidate parameter value, and the product performance degradation parameter is obtained.

In a possible implementation, as described above, there are multiple sets of candidate parameter values, i.e., multiple sets of unknown parameters b and k. Accordingly, the correlation parameters r obtained by substituting the multiple sets of candidate parameter values are different, that is, multiple correlation parameters r can be obtained.

In step S303, the target parameter value is determined from the multiple candidate parameter values based on the correlation parameter corresponding to each set of candidate parameter values, and the target parameter value is used as the parameter value of the unknown parameter included in the candidate function to obtain an intermediate function corresponding to the candidate function.

The target parameter value refers to the candidate parameter value that can maximize Σᵢ₌₂ⁿrᵢ.

In a possible implementation, the unknown parameters b and k that maximize Σᵢ₌₂ⁿrᵢ are used as the target parameter value to be substituted into the corresponding candidate function to obtain the intermediate function.

In an embodiment, the determining the target function that satisfies the preset selection condition from the plurality of intermediate functions includes: determining a correlation parameter between each intermediate function and the product performance degradation parameter, and determining the intermediate function with the largest corresponding correlation parameter as the target function.

In a possible implementation, the present disclosure can determine the target parameter values of a plurality of intermediate functions, then obtain Σᵢ₌₂ⁿrᵢ of each intermediate function based on the target parameter value and the correlation parameter, and determine the intermediate function corresponding to Σᵢ₌₂ⁿrᵢ with the largest value among the plurality of Σᵢ₌₂ⁿrᵢ as the target function.

In one of the embodiments, as shown in FIG. 4, the determining, based on the target function, the reliability function corresponding to the performance includes the following steps S401 to S402.

In step S401, a Wiener process function is determined, based on the target function, and the Wiener process function is solved to obtain a parameter value of an unknown parameter included in the Wiener process function.

In a possible implementation, the Wiener process function is as follows:

$$y = ax + σ B ( x )$$

where a refers to a drift coefficient, a refers to a diffusion coefficient, B(x) refers to a Brownian drift function, x refers to a performance degradation function of the target product, i.e., the target function.

The present disclosure takes into account that the degradation of the performance parameters of the target product over time is non-linear, so the Wiener process function used in the present disclosure is as follows:

$$y = a β ( x ; b , k ) + σ B ( β ( x ; b , k ) )$$

where a∈N(μ,σ_{μ}), and N(μ,σ_{μ}) refers to the normal distribution. The maximum likelihood estimation is then used to determine the parameter value of each of the unknown parameters α, μ and σ_{μ}.

In step S402, the reliability function corresponding to the performance is determined, based on the parameter value of the unknown parameter included in the Wiener process function and the target function.

The reliability function is the reliability function of the performance degradation and failure, then the unreliability function involved below is the unreliability function of the performance degradation and failure.

In a possible implementation, the unreliability function corresponding to the performance of the target product F(x) is as follows:

$$F ( x ) = ϕ ( A ) + exp ( C ) \cdot ϕ ( B )$$

$$where$$

$$A = {[ a β ( x ; b , k ) - c ] [ {σ}^{2} β ( x ; b , k ) + {σ}_{μ}^{2} {β ( x ; b , k )}^{2} ]}^{- 0.5} ,$$

$$B = - {σ}^{- 2} [ 2 {σ}_{μ}^{2} c β ( x ; b , k ) + {{σ}^{2} ( c + μ β ( x ; b , k ) ) ] [ {σ}^{2} β ( x ; b , k ) + {σ}_{μ}^{2} {β ( x ; b , k )}^{2} ]}^{- 0.5} \text{} ,$$

$$and$$

$$C = \frac{2 μ c {σ}^{2} + 2 {σ}_{μ}^{2} {c}^{2}}{{σ}^{4}} ,$$

where c refers to a failure threshold, Φ( ) refers to a standard normal distribution function, then the reliability function corresponding to the performance of the target product is R(x), and R(x)=1−F(x).

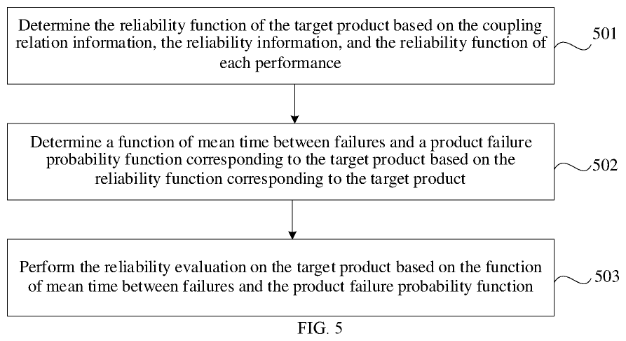

In one of the embodiments, as shown in FIG. 5, the performing, based on the coupling relation information, the redundancy information, and the reliability function of each performance, the reliability evaluation of the target product includes the following steps S501 to S503.

In step S501, the reliability function of the target product is determined based on the coupling relation information, the reliability information, and the reliability function of each performance.

In a possible implementation, it's assumed that the target product has m performances, the (j−1)-th performance among these m performances has a coupling relationship with the j-th performance, and the remaining performances are independent of each other, where j=2, 3, . . . , m−1, and there is no redundant information, then the reliability function of the target product is as follows:

$$R ( x ) = {R}_{1} ( x ) \times {R}_{2} ( x ) \times … \times C ( {R}_{j - 1} ( x ) ,$$

$${R}_{j} ( x ) ; θ ) \times … \times {R}_{m} ( x )$$

where C( ) is a link function, and θ is an unknown parameter of the link function. θ can be obtained by fitting and solving the link function.

In another possible implementation, it's assumed that the target product has m performances, the (j−1)-th performance among these m performances has a coupling relationship with the j-th performance, and the remaining performances are independent of each other, where j=2, 3, . . . , m−1, and there is no redundant information, then the unreliability function of the target product is as follows: F(x)=1−[1−F₁(x)]×[1−F₂(x)]× . . . ×C(1−Fⱼ₋₁(x), 1−Fⱼ(x); θ)× . . . ×[1−Fₘ(x)]. The reliability function of the target product is as follows: R(x)=1−F(x).

In another possible implementation, it's assumed that the target product has m performances, the (j−1)-th performance among these m performances has a coupling relationship with the j-th performance, and the remaining performances are independent of each other, where j=2, 3, . . . , m−1, and there is a redundant information, then the reliability function of the target product is as follows: R(x)=1−[1−R₁(x)]×[1−R₂(x)]× . . . ×[1−C(Rⱼ₋₁(x), Rⱼ(x); θ)]× . . . ×[1−Rₘ(x)].

In another possible implementation, it's assumed that the target product has m performances, the (j−1)-th performance among these m performances has a coupling relationship with the j-th performance, and the remaining performances are independent of each other, where j=2, 3, . . . , m−1, and there is a redundant information, then the unreliability function of the target product is as follows: F(x)=F₁(x)×F₂(x)× . . . ×C(1−Fⱼ₋₁(x), 1−Fⱼ(x); θ)× . . . ×Fₘ(x). The reliability function of the target product is as follows: R(x)=1−F(x).

In step S502, a function of mean time between failures and a product failure probability function corresponding to the target product are determined, based on the reliability function corresponding to the target product.

In a possible implementation, the function of mean time between failures MTBF is as follows: MTBF=∫₀^{∞}R(x)dt. Assuming that the life of the target product follows an exponential distribution function, the product failure probability function is as follows:

$$λ = \frac{1}{MTBF} = \frac{1}{{\int }_{0}^{∞} R ( x ) dt} ,$$

where λ represents the product failure probability.

In step S503, the reliability evaluation of the target product is performed, based on the function of mean time between failures and the product failure probability function.

In a possible implementation, the reliability evaluation of the target product can be determined, based on the function of mean time between failures MTBF of the target product and the product failure probability function A of the target product.

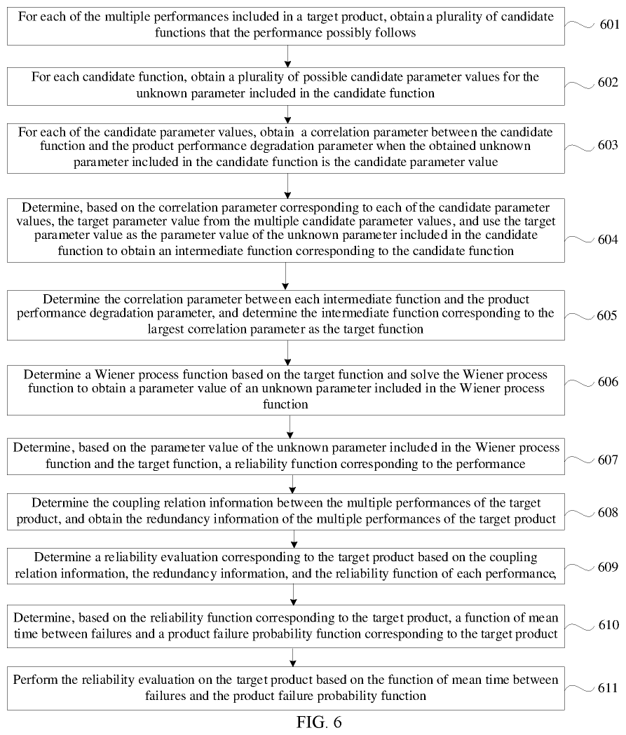

In an embodiment, as shown in FIG. 6, another method for reliability evaluation based on multiple performance degradation is provided, including the following steps S601 to S611.

In step S601, for each of the multiple performances of a target product, a plurality of candidate functions that the performance possibly follows is obtained.

In step S602, for each candidate function, a plurality of possible candidate parameter values for an unknown parameter included in the candidate function are obtained.

In step S603, for each of candidate parameter values, the correlation parameter between the candidate function, the unknown parameter of which is the candidate parameter value, and the product performance degradation parameter is obtained.

In step S604, the target parameter value is determined from the multiple candidate parameter values based on the correlation parameter corresponding to each of the candidate parameter values, and the target parameter value is used as the parameter value of the unknown parameter included in the candidate function to obtain an intermediate function corresponding to the candidate function.

In step S605, the correlation parameters between the intermediate functions and the product performance degradation parameter are determined, and the intermediate function corresponding to the largest correlation parameter is determined as the target function.

In step S606, a Wiener process function is determined based on the target function, and the Wiener process function is solved to obtain a parameter value of an unknown parameter included in the Wiener process function.

In step S607, a reliability function corresponding to the performance is determined, based on the parameter value of the unknown parameter included in the Wiener process function and the target function.

In step S608, the coupling relation information between the multiple performances of the target product is determined, and the redundancy information of the multiple performances of the target product is obtained.

In step S609, a reliability function corresponding to the target product is determined based on the coupling relation information, the redundancy information, and the reliability function of each performance.

In step S610, a function of mean time between failures and a product failure probability function corresponding to the target product are determined based on the reliability function corresponding to the target product.

In step S611, the reliability evaluation is performed on the target product is performed based on the function of mean time between failures and the product failure probability function.

In an optional embodiment of the present disclosure, in order to better understand the solution provided in the present disclosure, it is assumed that a certain product has five performances, and the reliability of the product needs to be evaluated. Firstly, a detailed analysis is conducted on one of the five performances of the product. Multiple typical linear functions are selected as candidate functions, and a target function that satisfies a preset selection condition is selected from the candidate functions. Finally, the optimal performance degradation function for this performance, i.e., the target function, is obtained as follows: β(x;b,k)=1−exp(−1.3×10⁻⁴×x^{0.962}). The Wiener process function determined based on the target function is as follows: y=a[1−exp(−1.3×10⁻⁴×x^{0.962})]+σB(1−ex p(−1.3×10⁻⁴×x^{0.962})). Then, the values of the parameters a, μ, and σ_{μ} are calculated, and the reliability function R₁(x) and unreliability function F₁(x) for this performance degradation failure are obtained. By using the same method, the reliability functions and unreliability functions of the remaining performances of the product are obtained. The reliability functions of the five performances of the product are R₁(x), R₂(x), R₃(x), R₄(x), and R₅ (x), respectively. The unreliability functions of the five performances of the products are F₁(x), F₂(x), F₃(x), F₄(x), and F₅(x), respectively. Assuming that in the five performances of the product, the third performance has a coupling relationship with the fourth performance, the remaining performances are independent of each other, and the product follows a non-redundant model, then the reliability function of the product is obtained as follows: R(x)=R₁(x)×R₂(x)×C(R₃(x), R₄(x); θ)×R₅(x). The unreliability function of the product is as follows: F(x)=1−[1−F₁(x)]×[1−F₂(x)]×C(1−F₃(x), 1−F₄(x); θ)×[1−F₅(x)]. The value of the parameter θ in the link function is obtained by solving the above equations. Then, the mean time between failures MTBF of the product is 25685 hours, obtained by MTBF=∫₀^{∞}R(x)dt. The failure probability of the product is determined based on the function that the product life follows. The mean time between failures MTBF of the product and the failure probability of the product represent the reliability evaluation of the product.

It should be understood that although the various steps in the flowcharts of the embodiments described above are shown in a sequence indicated by the arrows, these steps are not necessarily executed in the order indicated by the arrows. Unless otherwise specified in this document, there is no strict order limitation on the execution of these steps, which can be executed in other orders. Moreover, at least some of the steps in the flowcharts of the embodiments described above may include multiple steps or stages, which may not necessarily be completed at the same time, but can be executed at different times. The execution order of these steps or stages may also not be sequential, but may alternate with at least some of the steps or stages in other steps.

Based on the same inventive concept, embodiments of the present disclosure also provide an apparatus for reliability evaluation based on multiple performance degradation for implementing the method for reliability evaluation based on multiple performance degradation described above. The implementations provided by the apparatus for solving the problem are similar to those described in the method described above, so the specific limitations in the one or more embodiments of the apparatus for reliability evaluation based on multiple performance degradation provided below may be referred to the limitations of the method for reliability evaluation based on multiple performance degradation described above, and will not be repeated herein.

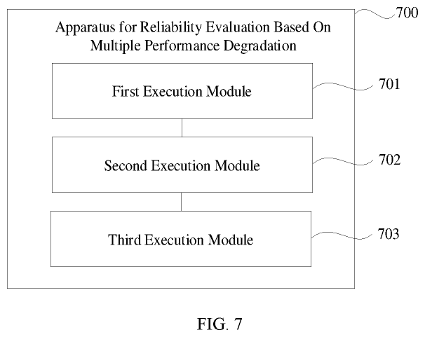

In an embodiment, as shown in FIG. 7, an apparatus for reliability evaluation based on multiple performance degradation is provided. The apparatus includes a first execution module 701, a second execution module 702 and a third execution module 703.

The first execution module 701 is configured to obtain, for each of the multiple performances included in a target product, a plurality of candidate functions that the performance possibly follows, determine a target function that satisfies a preset selection condition from the plurality of candidate functions, and determine, based on the target function, a reliability function corresponding to the performance.

The second execution module 702 is configured to determine the coupling relation information between the multiple performances of the target product, and obtain the redundancy information of the multiple performances of the target product.

The third execution module 703 is configured to perform, based on the coupling relation information, the redundancy information, and the reliability function of each performance, a reliability evaluation on the target product.

In an embodiment, the first execution module 701 is specifically configured to calculate, using a maximal correlation coefficient algorithm, a parameter value of an unknown parameter included in each candidate function to obtain a plurality of intermediate functions, and determine the target function that satisfies the preset selection condition from the plurality of intermediate functions.

In an embodiment, the first execution module 701 is specifically configured to: obtain, for each candidate function, a plurality of possible candidate parameter values for an unknown parameter included in the candidate function; obtain, for each of the candidate parameter values, the correlation parameter between the candidate function, the unknown parameter of which is the candidate parameter value, and the product performance degradation parameter; and determine, based on the correlation parameter corresponding to each of the candidate parameter values, the target parameter value from the multiple candidate parameter values, and use the target parameter value as the parameter value of the unknown parameter included in the candidate function to obtain an intermediate function corresponding to the candidate function.

In an embodiment, the first execution module 701 is specifically configured to determine a correlation parameter between each intermediate function and the product performance degradation parameter to obtain a plurality of intermediate functions, and determine the intermediate function corresponding to the largest correlation parameter as the target function.

In an embodiment, the first execution module 701 is specifically configured to: determine a Wiener process function based on the target function and solve the Wiener process function to obtain a parameter value of an unknown parameter included in the Wiener process function; and determine, based on the parameter value of the unknown parameter included in the Wiener process function and the target function, a reliability function corresponding to the performance.

In an embodiment, the coupling relation information is configured to indicate the performances of the plurality of performances that are in coupling relation with each other and the performances that are independent of each other. The redundancy information is configured to indicate that the plurality of performances of the target product are in a non-redundancy situation or a redundancy situation, with the non-redundancy situation being a situation in which the target product fails if any performance of the target product fails, and the redundancy situation being a situation in which the target product fails if all of the performances of the target product fail.

In an embodiment, the third execution module 703 is specifically configured to: determine, based on the coupling relation information, the reliability information, and the reliability function of each performance, the reliability function of the target product; determine, based on the reliability function corresponding to the target product, a function of mean time between failures and a product failure probability function corresponding to the target product; and perform, based on the function of mean time between failures and the product failure probability function, the reliability evaluation on the target product.

The modules in the above-described apparatus for reliability evaluation based on multiple performance degradation may be realized in whole or in part by software, hardware, and combinations thereof. Each of the above-described modules may be embedded in hardware in or independent of a processor in the computer device, or may be stored in software in a memory in the computer device so that the processor can be called to perform operations corresponding to each of the above-described modules.

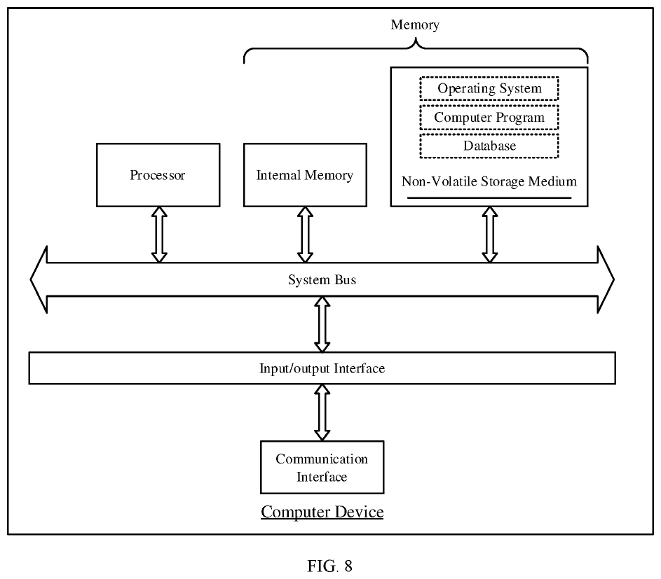

In an embodiment, a computer device is provided. The computer device may be a server, a schematic diagram of an internal configuration of which is shown in FIG. 8. The computer device includes a processor, a memory, an input/output interface (Input/Output, or I/O for short), and a communication interface. The processor, the memory and the Input/Output interface are connected through a system bus, and the communication interface is connected to the system bus through the Input/Output interface. The processor of the computer device is used to provide computing and control capabilities. The memory of the computer device includes a non-transitory storage medium and an internal memory. The non-transitory storage medium stores an operating system, a computer program, and a database. The internal memory provides an environment for the operation of the operating system and the computer program in the non-transitory storage medium. The database of the computer device is used to store data. The input/output interface of the computer device is used to exchange information between the processor and an external device. The communication interface of the computer device is used to communicate with an external terminal through a network connection. The computer program is executed by the processor to implement the method for reliability evaluation based on multiple performance degradation.

It will be understood by those skilled in the art that the structure illustrated in FIG. 8 is only a block diagram of a portion of the structure related to the solution of the present disclosure, and does not constitute a limitation on the computer device to which the solution of the present disclosure is applied. The specific computer device may include more or less components than those shown in the figures, or may combine certain components, or have a different component arrangement.

In an embodiment, a computer device is provided. The computer device includes a memory and a processor, the memory storing a computer program. The processor implements the following steps when executing the computer program:
for each of the multiple performances of a target product, obtaining a plurality of candidate functions that the performance possibly follows, determining a target function that satisfies a preset selection condition from the plurality of candidate functions, and determining, based on the target function, a reliability function corresponding to the performance; determining the coupling relation information between the multiple performances of the target product, and obtaining the redundancy information of the multiple performances of the target product; and performing, based on the coupling relation information, the redundancy information, and the reliability function of each performance, a reliability evaluation on the target product.

In one of the embodiments, to determine the target function that satisfies the preset selection condition from the plurality of candidate functions, the processor implements the following steps when executing the computer program: calculating, using a maximal correlation coefficient algorithm, a parameter value of an unknown parameter included in each candidate function to obtain a plurality of intermediate functions; and determining the target function that satisfies the preset selection condition from the plurality of intermediate functions.

In one of the embodiments, to calculate, using the maximal correlation coefficient algorithm, the parameter value of the unknown parameter included in each candidate function to obtain the plurality of intermediate functions, the processor implements the following steps when executing the computer program: for each candidate function, obtaining a plurality of possible candidate parameter values for the unknown parameter included in the candidate function; for each of the candidate parameter values, obtaining the correlation parameter between the candidate function, the unknown parameter of which is the candidate parameter value, and the product performance degradation parameter; and determining, based on the correlation parameter corresponding to each of the candidate parameter values, the target parameter value from the multiple candidate parameter values, and using the target parameter value as the parameter value of the unknown parameter included in the candidate function to obtain an intermediate function corresponding to the candidate function.

In one of the embodiments, to determine the target function that satisfies the preset selection condition from the plurality of intermediate functions, the processor implements the following steps when executing the computer program: determining a correlation parameter between each intermediate function and the product performance degradation parameter, and determining the intermediate function corresponding to the largest correlation parameter as the target function.

In one of the embodiments, to determine, based on the target function, the reliability function corresponding to the performance, the processor implements the following steps when executing the computer program: determining, based on the target function, a Wiener process function and solving the Wiener process function to obtain a parameter value of an unknown parameter included in the Wiener process function; and determining, based on the parameter value of the unknown parameter included in the Wiener process function and the target function, the reliability function corresponding to the performance.

In one of the embodiments, the coupling relation information is configured to indicate the performances of the plurality of performances that are in coupling relation with each other and the performances that are independent of each other. The redundancy information is configured to indicate that the plurality of performances of the target product are in a non-redundancy situation or a redundancy situation, with the non-redundancy situation being a situation in which the target product fails if any performance of the target product fails, and the redundancy situation being a situation in which the target product fails if all of the performances of the target product fail.

In one of the embodiments, to perform the reliability evaluation on the target product based on the coupling relation information, the redundancy information, and the reliability function of each performance, the processor implements the following steps when executing the computer program: determining the reliability function of the target product based on the coupling relation information, the reliability information, and the reliability function of each performance; determining a function of mean time between failures and a product failure probability function corresponding to the target product based on the reliability function corresponding to the target product; and performing, based on the function of mean time between failures and the product failure probability function, the reliability evaluation on the target product.

In an embodiment, a computer-readable storage medium having a computer program stored thereon is provided. The processor implements the following steps when executing the computer program:
for each of the multiple performances of a target product, obtaining a plurality of candidate functions that the performance possibly follows, determining a target function that satisfies a preset selection condition from the plurality of candidate functions, and determining, based on the target function, a reliability function corresponding to the performance; determining the coupling relation information between multiple performances of the target product, and obtaining the redundancy information of the multiple performances of the target product; and performing a reliability evaluation of the target product based on the coupling relation information, the redundancy information, and the reliability function of each performance.

In one of the embodiments, to determine the target function that satisfies the preset selection condition from the plurality of candidate functions, the processor implements the following steps when executing the computer program: calculating, using a maximal correlation coefficient algorithm, a parameter value of an unknown parameter included in each candidate function to obtain a plurality of intermediate functions; and determining the target function that satisfies the preset selection condition from the plurality of intermediate functions.

In one of the embodiments, to calculate, using maximal correlation coefficient algorithm, the parameter value of the unknown parameter included in each candidate function to obtain the plurality of intermediate functions, the processor implements the following steps when executing the computer program: for each candidate function, obtaining a plurality of possible candidate parameter values for the unknown parameter included in the candidate function; for each set of candidate parameter values, obtaining the correlation parameter between the candidate function, the unknown parameter of which is the candidate parameter value, and the product performance degradation parameter; and determining, based on the correlation parameter corresponding to each of the candidate parameter values, the target parameter value from the multiple candidate parameter values, and using the target parameter value as the parameter value of the unknown parameter included in the candidate function to obtain an intermediate function corresponding to the candidate function.

In one of the embodiments, to determine the target function that satisfies the preset selection condition from the plurality of intermediate functions, the processor implements the following steps when executing the computer program: determining a correlation parameter between each intermediate function and the product performance degradation parameter, and determining the intermediate function corresponding to the largest correlation parameter as the target function.

In one of the embodiments, to determine, based on the target function, the reliability function corresponding to the performance, the processor implements the following steps when executing the computer program: determining, based on the target function, a Wiener process function and solving the Wiener process function to obtain a parameter value of an unknown parameter included in the Wiener process function; and determining, based on the parameter value of the unknown parameter included in the Wiener process function and the target function, the reliability function corresponding to the performance.

In one of the embodiments, the coupling relation information is configured to indicate the performances of the plurality of performances that are in coupling relation with each other and performances that are independent of each other; and the redundancy information is configured to indicate that the plurality of performances of the target product are in a non-redundancy situation or a redundancy situation, with the non-redundancy situation being a situation in which the target product fails if any performance of the target product fails, and the redundancy situation being a situation in which the target product fails if all of the performances of the target product fail.

In one of the embodiments, to perform the reliability evaluation on the target product based on the coupling relation information, the redundancy information, and the reliability function of each performance, the processor implements the following steps when executing the computer program: determining the reliability function of the target product based on the coupling relation information, the reliability information, and the reliability function of each performance; determining, based on the reliability function corresponding to the target product, a function of mean time between failures and a product failure probability function corresponding to the target product; and performing, based on the function of mean time between failures and the product failure probability function, the reliability evaluation on the target product.

In an embodiment, a computer program product including a computer program is provided. The processor implements the following steps when executing the computer program:
for each of the multiple performances of a target product, obtaining a plurality of candidate functions that the performance possibly follows, determining a target function that satisfies a preset selection condition from the plurality of candidate functions, and determining, based on the target function, a reliability function corresponding to the performance; determining the coupling relation information between the multiple performances of the target product, and obtaining the redundancy information of the multiple performances of the target product; and performing, based on the coupling relation information, the redundancy information, and the reliability function of each performance, a reliability evaluation on the target product.

In one of the embodiments, to determine the target function that satisfies the preset selection condition from the plurality of candidate functions, the processor implements the following steps when executing the computer program: calculating, using a maximal correlation coefficient algorithm, a parameter value of an unknown parameter included in each candidate function to obtain a plurality of intermediate functions; and determining the target function that satisfies the preset selection condition from the plurality of intermediate functions.

In one of the embodiments, to calculate, using the maximal correlation coefficient algorithm, the parameter value of the unknown parameter included in each candidate function to obtain the plurality of intermediate functions, the processor implements the following steps when executing the computer program: for each candidate function, obtaining a plurality of possible candidate parameter values for the unknown parameters included in the candidate function; for each of the candidate parameter values, obtaining the correlation parameter between the candidate function, the unknown parameter of which is the candidate parameter value, and the product performance degradation parameter; and determining, based on the correlation parameter corresponding to each of the candidate parameter values, the target parameter value from the multiple candidate parameter values, and using the target parameter value as the parameter value of the unknown parameter included in the candidate function to obtain an intermediate function corresponding to the candidate function.

In one of the embodiments, to determine the target function that satisfies the preset selection condition from the plurality of intermediate functions, the processor implements the following steps when executing the computer program: determining a correlation parameter between each intermediate function and the product performance degradation parameter, and determining the intermediate function corresponding to the largest correlation parameter as the target function.

In one of the embodiments, to determine, based on the target function, the reliability function corresponding to the performance, the processor implements the following steps when executing the computer program: determining based on the target function, a Wiener process function and solving the Wiener process function to obtain a parameter value of an unknown parameter included in the Wiener process function; and determining, based on the parameter value of the unknown parameter included in the Wiener process function and the target function, the reliability function corresponding to the performance.

In one of the embodiments, the coupling relation information is configured to indicate the performances of the plurality of performances that are in coupling relation with each other and the performances that are independent of each other; and the redundancy information is configured to indicate that the plurality of performances of the target product are in a non-redundancy situation or a redundancy situation, with the non-redundancy situation being a situation in which the target product fails if any performance of the target product fails, and the redundancy situation being a situation in which the target product fails if all of the performances of the target product fail.

In one of the embodiments, to perform the reliability evaluation on the target product based on the coupling relation information, the redundancy information, and the reliability function of each performance, the processor implements the following steps when executing the computer program: determining, based on the coupling relation information, the reliability information, and the reliability function of each performance, the reliability function of the target product; determining, based on the reliability function corresponding to the target product, a function of mean time between failures and a product failure probability function corresponding to the target product; and performing, based on the function of mean time between failures and the product failure probability function, the reliability evaluation on the target product.

A person of ordinary skill in the art can understand that realizing all or part of the processes in the methods of the above embodiments is possible by means of a computer program to instruct the relevant hardware to accomplish the same. The above-mentioned computer program can be stored in a non-volatile computer-readable storage medium, and when executed, the computer program may include processes such as the processes of the embodiments of the respective methods described above. Among other things, any reference to a memory, database, or other medium used in the embodiments provided in the present disclosure may include at least one of non-volatile or volatile memory. Non-volatile memories may include read-only memory (ROM), magnetic tape, floppy disk, flash memory, optical memory, high-density embedded non-volatile memories, resistance-resistive memory (ReRAM), magnetoresistive random access memory (MRAM), ferroelectric random access memory (FRAM), phase change memory (PCM), graphene memory and so on. The volatile memory may include a random access memory (RAM) or an external cache memory, and the like. As an illustration and not as a limitation, the RAM may be in various forms, such as static random access memory (SRAM) or dynamic random access memory (DRAM), and the like. The databases involved in the embodiments provided in the present disclosure may include at least one of a relational database or a non-relational database. The non-relational database may include a blockchain-based distributed database and the like, without limitation. The processor involved in the embodiments provided in the present disclosure may be a general-purpose processor, a central processing unit, a graphics processor, a digital signal processor, a programmable logician, a data processing logician based on quantum computing, and the like, without limitation.

The various technical features of the above-described embodiments may be combined arbitrarily, and not all possible combinations of the various technical features of the above-described embodiments have been described for the sake of conciseness of description. However, as long as there is no contradiction in the combinations of these technical features, they should be considered to be within the scope of the present specification as recorded herein.

The above-described embodiments express only several embodiments of the present disclosure, which are described in a more specific and detailed manner, but are not to be construed as a limitation of the scope of the patent disclosure. It should be pointed out that, for a person of ordinary skill in the art, several deformations and improvements can be made without departing from the conception of the present disclosure, all of which fall within the scope of protection of the present disclosure. Therefore, the scope of protection of the patent disclosure shall be subject to the attached claims.

1. A method for reliability test based on multiple performance degradation, comprising:
for each of multiple performances of a product under test, obtaining, by a computer device, a plurality of first functions corresponding to the performance;
for each of the first functions, obtaining, by the computer device, a plurality of parameter values provided for an unknown parameter of the first function;
for each of the parameter values, obtaining, by the computer device, a correlation parameter between the first function, when the unknown parameter of which is the parameter value, and a product performance degradation parameter;
determining, by the computer device, a target parameter value from the plurality of parameter values based on the correlation parameter corresponding to each of the parameter values, and using the target parameter value as the parameter value of the unknown parameter of the first function to obtain a second function corresponding to the first function, wherein the second function is the first function that comprises the parameter value of the unknown parameter;
determining, by the computer device, a target function that satisfies a preset condition from a plurality of second functions;
determining, by the computer device, based on the target function, a reliability function corresponding to the performance;
determining, by the computer device, coupling relation information between the multiple performances of the product under test and obtaining redundancy information of the multiple performances of the product under test, the coupling relation information being configured to indicate the performances of the multiple performances that are in coupling relation with each other and the performances that are independent of each other, the redundancy information being configured to indicate that the multiple performances of the product under test are in a non-redundancy situation or a redundancy situation, the non-redundancy situation being a situation in which the product under test fails if any performance of the product under test fails, and the redundancy situation being a situation in which the product under test fails if all of the performances of the product under test fail;
determining, by the computer device, a reliability function corresponding to the product under test based on the coupling relation information, the redundancy situation information, and the reliability function corresponding to each of the performances;
determining, by the computer device, a function of product mean time between failures and a product failure probability function corresponding to the product under test based on the reliability function corresponding to the product under test; and
performing, by the computer device, a reliability test on the product under test based on the function of product mean time between failures and the product failure probability function; and
generating a test report based on a result of the reliability test and transmitting the test report to a terminal device; and
replacing, based on the test report, the product under test.

2. The method according to claim 1, the determining the target function that satisfies the preset condition from the plurality of second functions, comprising:
determining a correlation parameter between each second function and the product performance degradation parameter, and determining the second function corresponding to a largest correlation parameter as the target function.

3. The method according to claim 1, the determining, based on the target function, the reliability function corresponding to the performance, comprising:
determining, based on the target function, a Wiener process function and solving the Wiener process function to obtain a parameter value of an unknown parameter included in the Wiener process function; and
determining, based on the parameter value of the unknown parameter included in the Wiener process function and the target function, the reliability function corresponding to the performance.

4. (canceled)

5. The method according to claim 3, wherein the reliability function is the reliability function of the performance degradation and failure.

6. An apparatus for reliability test based on multiple performance degradation, comprising:
a first execution module configured to:
for each of multiple performances of a product under test, obtain a plurality of first functions corresponding to the performance,
for each of the first functions, obtain a plurality of parameter values provided for an unknown parameter of the first function;
for each of the parameter values, obtain a correlation parameter between the first function, when the unknown parameter of which is the parameter value, and a product performance degradation parameter;
determine a target parameter value from the plurality of parameter values based on the correlation parameter corresponding to each of the parameter values, and use the target parameter value as the parameter value of the unknown parameter of the first function to obtain an second function corresponding to the first function;
determine a target function that satisfies a preset condition from a plurality of second functions; and
determine, based on the target function, a reliability function corresponding to the performance;
a second execution module configured to determine coupling relation information between the multiple performances of the product under test, and obtain redundancy information of the multiple performances of the product under test, the coupling relation information being configured to indicate the performances of the multiple performances that are in coupling relation with each other and the performances that are independent of each other, the redundancy information being configured to indicate that the multiple performances of the product under test are in a non-redundancy situation or a redundancy situation, the non-redundancy situation being a situation in which the product under test fails if any performance of the product under test fails, and the redundancy situation being a situation in which the product under test fails if all of the performances of the product under test fail; and
a third execution module configured to determine a reliability function corresponding to the product under test based on the coupling relation information, the redundancy situation information, and the reliability function corresponding to each of the performances, determine a function of product mean time between failures and a product failure probability function corresponding to the product under test based on the reliability function corresponding to the product under test, perform a reliability test on the product under test based on the function of product mean time between failures and the product failure probability function, generate a test report based on a result of the reliability test and transmit the test report to a terminal device, and replace, based on the test report, the product under test.

7. The apparatus according to claim 6, wherein the first execution module is specifically configured to determine a correlation parameter between each second function and the product performance degradation parameter, and determine the second function corresponding to a largest correlation parameter as the target function.

8. The apparatus according to claim 6, wherein the first execution module is specifically configured to:
determine a Wiener process function based on the target function and solve the Wiener process function to obtain a parameter value of an unknown parameter included in the Wiener process function; and
determine the reliability function corresponding to the performance based on the target function and the parameter value of the unknown parameter included in the Wiener process function.

9. A computer device, comprising a memory and a processor, the memory storing a computer program, steps of the method according to claim 1 being implemented when the computer program is executed by the processor.

10. A computer-readable storage medium having a computer program stored thereon, steps of the method according to claim 1 being implemented when the computer program is executed by a processor.
